(19) United States
(12) Patent Application Publication
(10) Pub. No.: US 2025/0147639 A1
(43) Pub. Date: May 8, 2025

(54) METHOD AND SYSTEM FOR INTERACTIVE NAVIGATION OF MEDIA FRAMES

(71) Applicant: Global Publishing Interactive, Inc., Troy, OH (US)

(72) Inventors: Robert Hoffer, Miami Beach, FL (US); Christopher Carter, Bloomingdale, IL (US); Shaun Rowan, Troy, OH (US)

(21) Appl. No.: 18/504,119

(22) Filed: Nov. 7, 2023

(51) Int. Cl. G06F 3/0483; G06F 40/30; G06T 7/11; G06T 7/13

(52) U.S. Cl. CPC G06F 3/0483; G06F 40/30; G06T 7/11; G06T 7/13; G06T 2207/20081

(57) ABSTRACT

Methods and systems are provided for automatic, adaptive navigation of digital comic book frames. A frame image of a comic book may include one or more discrete panels. The frame image can be parsed using a first machine-learning model to derive visual features associated with the frame image and a second machine-learning model to derive contextual information associated with words appearing in each panel. A frame configuration can be defined that defines a transition for navigating between a sequence of views of the frame image, where each view corresponds to a panel or a portion thereof.

### TECHNICAL FIELD

This disclosure relates generally to interactive navigation of media frames, and more particularly to interactive navigation of comic book frames using contextual text analysis and machine-learning.

### BACKGROUND

Graphical media such as comic books or graphic novels include a sequence of frames (e.g., pages, etc.) that include one or more panels that each depict portions of a story. The consumption of graphical media is beginning to shift from print-based media (e.g., traditional paper comic books, etc.) to digital formats that can be viewed on computing devices, mobile devices, etc. The digital formats represent graphical media similar to their print-based counterparts. For example, digital versions of graphical media may include a series of images with each image corresponding to a frame of the graphical media or a panel of a frame.

Navigating digital formats of graphical media can be arduous and vary across devices. For example, most devices display an image in its entirety causing images with graphics and text to appear too small to read especially images with multiple panels. Some devices may have tools to increase the accessibility of navigating digital formats such as scrolling or zoom, not all devices or applications support these tools. For instance, some mobile device environments do not support scrolling and lack adaptive zooming, which may prevent consumption of some graphic formats within those mobile device environments.

### SUMMARY

Methods are described herein for interactive navigation of media frames. The methods may include receiving a frame image including one or more panels; executing a first machine-learning model using the frame image, wherein the first machine-learning model segments the frame image into one or more image regions; executing a second machine-learning model using the frame image, wherein the second machine-learning model identifies alphanumeric text and a context corresponding to the one or more panels; generating a frame configuration using the frame image, the one or more image regions, and the context corresponding to the one or more panels, wherein the frame configuration identifies a sequence of views to present the frame image, wherein each view of the sequence of views corresponds to a panel of the one or more panels or a portion thereof; and facilitating execution of the frame configuration causing a presentation of a first view of the sequence of views.

The systems described herein for interactive navigation of media frames. The systems may include one or more processors and a non-transitory computer-readable medium storing instructions that, when executed by the one or more processors, cause the one or more processors to perform any of the methods as previously described.

The non-transitory computer-readable media described herein may store instructions which, when executed by one or more processors, cause the one or more processors to perform any of the methods as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of example a panel flow system configured to generate frame configurations for interactive navigation of comic book frames according to aspects of the present disclosure.

FIG. 2 illustrates a block diagram of an example panel flow system that generates local frame configurations for interactive navigation of comic book frames by mobile devices according to aspects of the present disclosure.

FIG. 3 illustrates a block diagram of an example panel flow system configured to stream frame configurations to remote devices for interactive navigation of comic book frames according to aspects of the present disclosure.

FIG. 4 illustrates an example frame image comprising one or more panels according to aspects of the present.

FIGS. 5A and 5B illustrate example views generated by a panel flow system from a frame image according to aspects of the present.

FIG. 6 illustrates a flowchart of an example process of interactive navigation of comic book frames using contextual text analysis and machine-learning according to aspects of the present disclosure.

FIG. 7 illustrates an example computing device architecture of an example computing device that can implement the various techniques described herein according to aspects of the present disclosure.

### DETAILED DESCRIPTION

Digital formats of graphical media (e.g., comic books, graphical novels, etc.) are often presented inconsistently across different device types, presented in illegible formats, and lack accessibility functionality that enables consumption by disabled users. The method and systems described herein provide for the interactive presentation and navigation of media frames of graphical content. In some examples, a panel flow may be provided for translating graphical media into a presentation format that improves legibility of graphical media across device types, provides interactive navigation functions for navigating across frames and panels, and provides tailored presentation of graphical media for particular device or user preferences. In some examples, the panel flow may include one or more machine-learning models configured to process the graphical and/or textual content within each panel and frame to generate a sequence of views with each view corresponding to a frame, panel, or portions thereof. The sequence of views can be navigated using an input device (e.g., such as, but not limited to, mouse and/or keyboard, touch interfaces, camera, microphone, or the like) and/or time based on user. The panel flow generates an interactive version of static graphical media with improve presentation and navigation.

The panel flow may receive graphical media or a portion thereof for processing. The graphical media may include one or more frames (e.g., which may correspond to one or more pages of a comic book or graphic novel, or the like) where each frame includes one or more panels. A panel may include a graphical scene with background, foreground, characters, dialog (e.g., such as speech bubbles, or the like), onomatopoeia, setting, objects, etc. The panel flow may define one or more views from a frame or panel that corresponds to a portion of the frame or panel. For example, a view may be an expanded portion (e.g., zoomed in, etc.) of the frame or panel, an isolated portion (e.g., cropped, segmented, etc.) of a frame or panel, a modified version of a frame or panel or portion thereof. The panel flow may then aggregate the one or more views into a frame configuration that defines a presentation sequence of the views.

The panel flow may include one or more machine-learning models trained to process portions of the graphical media for generating views. The one or more machine-learning models may be stored in a server (for remote pre-processing of the graphical media) or within local memory of a user device (e.g., computing device, mobile device such a smartphone or tablet, etc.). The one or more machine-learning models may include a first machine-learning model that may process the graphical components of the graphical media and/or a second machine-learning model that may identify and process text within the graphical media. In some instances, the first machine-learning model may be trained to perform edge detection (e.g., to detect panels within a frame, etc.), image segmentation (e.g., detect different components within a frame such as background, foreground, characters, objects, text bubbles, onomatopoeia or other text within the image, etc.), classifiers (e.g., to distinguish the different components detected, etc.), sematic or contextual analysis (e.g., determine a meaning or context associated with a panel), and/or the like. Example machine-learning models included in the first machine-learning model include, but is not limited to, neural networks (e.g., such as recurrent neural networks, mask recurrent neural networks, convolutional neural networks, faster convolutional neural networks, etc.), you only look once (YOLO), EfficientDet, deep learning networks, combinations thereof, or the like.

The second machine-learning model may be trained to identify text within a panel such as (but not limited) speech bubbles or other dialog, narration or stage direction, onomatopoeia, etc. and determine semantic and/or contextual information from the identified text (e.g., such the meaning of the text, an overall sentiment or mood of the panel, topic, actions performed by characters, etc.). Examples of second machine-learning models include, but are not limited to, transformers (generative pre-trained transformers (GPT), Bidirectional Encoder Representations from Transformers (BERTs), text-to-text-transfer-transformer (T5), or the like), generative adversarial networks (GANs), recurrent neural networks (e.g., long short-term memory (LSTM), etc.), recurrent gated units (GRUs), combinations thereof, or the like.

The panel flow may use the output from the first machine-learning model and the second machine-learning model to generate the one or more views. For example, a panel with dialog between two characters may include a first view depicting an expanded portion of the panel representing the first character and dialog associated with the first character and a second view depicting an expanded portion of the panel representing the second character and dialog associated with the second character. The output from the first machine-learning model and the second machine-learning model may also be used to determine the order in which the first view and the second view should be presented. For instance, the relative positions of the dialog text or the text itself may be indicative of the order in which the views should be presented.

The one or more machine-learning models may also include machine-learning models trained to predict navigation preferences for a user. For example, navigation preferences may include a time interval between presentations of a panel or view, an input type to trigger a navigation operation (e.g., such as transitioning to a subsequent or previous panel or view, adding or removing accessibility functionality, increasing or decreasing a volume for special effects or spoken dialog, etc.), or the like. Examples of input types include, but are not limited to, keyboard or mouse, gesture (e.g., via a touch interface or visual classifier), eye tracking, device motion (e.g., via one or more accelerometers and/or gyroscopes, etc.), voice commands, and/or the like. The machine-learning model may use historical interactions between a user and the panel flow such as previous presentations of graphical media, settings, feedback, or the like. The output from the machine-learning model may be usable by panel flow to modify navigation of graphical media for the user. The machine-learning model may operate before, during (e.g., in real time), or after presentation of graphical media. For example, the machine-learning model may use characteristics of a current presentation of graphical media to modify navigation of the remaining portion of the presentation. For instance, the machine-learning model may monitor a rate at which a user provides input to transition to a subsequent view or panel to define a timer. The timer may be used to cause the presentation of the graphical media to automatically transition to a subsequent panel or view.

In some instances, the panel flow may use additional features, machine-learning models, settings, functions, or the like to increase a degree of interactivity, accessibility, or customization of the frame configuration. For example, the panel flow may add accessibility for disabled users such as alternative input for transition to between views, text-to-speech machine-learning models for those with trouble reading, language translations, changes in font for text, changes in color (e.g., to reduce an impact of color blindness, etc.), highlighting portions of the panel or view, highlighting portions of the text, combinations thereof, or the like.

The frame configuration can be executed within an application or browser of the user device to present the views of the graphical media. In some instances, the frame configuration can be pre-generated (e.g., by a remote device or locally on the user device). In other instances, the frame configuration may be generated upon selection of the graphical media. If the frame configuration is generated at the user device, the user device may retrieve the graphical media and generate and execute the frame configuration. If the frame configuration is generated remotely, the user device may retrieve the frame configuration from the remote source. The presentation of the frame configuration may begin with a first view of the sequence of views. The user device may transition to a subsequent view (or a previous view) by providing input (e.g., a gesture, device input, voice command, eye tracking input, device motion such as shaking or turning, combinations thereof, or the like) or automatically based on a time interval (as previously described). In some instances, the presentation of the graphical media may be streamed from the remote device. In those instances, the remote device may transition to a subsequent view automatically (e.g., based on a timer as previously described) or upon receiving input from the user device.

In an illustrative example, a computing device may receive receiving a frame image including one or more panels. The frame image may be an image of one or more pages of graphical media in which each panel of the one or more panels corresponds to a portion of a narrative that includes graphical and textual elements. The computing device may be configured to process frame images to translate the graphical media into an interactive format with improved readability, accessibility, customization. In some instances, the computing device may be configured to both process graphical media and present the graphical media. For instance, the computing device may be a mobile device (e.g., such as a smartphone, tablet, e-reader, or the like) that receives graphical media and process the graphical media for presentation (e.g., in real time or prior to presentation). Alternatively, the computing device may be server or remote device configured to stream the presentation of the graphical media to one or more user devices via an application or browser. In other instances, the computing device may be configured to pre-process graphical media for later presentation by the computing device or one or more user devices. In those instances, the computing device may be a server or other device that receives a request for graphical media and transmits an interactive version of the graphical media to the requesting device.

The computing device may execute a first machine-learning model using the frame image. The first machine-learning model may be trained to process the graphical component of the frame image such as, but not limited to, image segmentation, edge detection, object and/or character identification, context classification, and/or the like. The first machine-learning model may include, but is not limited to, neural networks (e.g., such as recurrent neural networks, mask recurrent neural networks, convolutional neural networks, faster convolutional neural networks, etc.), you only look once (YOLO), EfficientDet, deep learning networks, combinations thereof, or the like. The first machine-learning model may be a single machine-learning model or an ensemble model (e.g., two or more machine-learning models). The computing device (or another device) may train the first machine-learning model using unsupervised, supervised, self-supervised, and/or transfer learning from training data including a set of frame images derived from graphical media.

The computing device execute a second machine-learning mode using the frame image to derive contextual information for text and onomatopoeia within the frame image. The second machine-learning model maybe trained to perform semantic analysis (e.g., derive a meaning of words and phrases), determine a topic of a panel or frame image, determine a mood or sentiment of a panel or frame image, associate a character of a frame image or panel with a portion of text (e.g., such as dialog spoken by the character, narration related to the character, etc.), derive an a sequence in which the dialog is intended to be read, identify an action depicted within a frame image or panel, associate the action with a character, combinations thereof, or the like. The second machine-learning model may include, but is not limited to, transformers (generative pre-trained transformers (GPT), Bidirectional Encoder Representations from Transformers (BERTs), text-to-text-transfer-transformer (T5), or the like), generative adversarial networks (GANs), recurrent neural networks (e.g., long short-term memory (LSTM), etc.), recurrent gated units (GRUs), combinations thereof, or the like. The second machine-learning model may be a single machine-learning model or an ensemble model (e.g., two or more machine-learning models). The computing device (or another device) may train the second machine-learning model using unsupervised, supervised, self-supervised, and/or transfer learning from training data including text and onomatopoeia extracted from graphical media.

The computing device may use the frame image, the one or more image regions, and the context corresponding to the one or more panels to generate a frame configuration. A frame configuration may include an identification of one or more views of the frame image (e.g., such as, but not limited to, the frame image, a panel of the frame image, a portion of a panel, a modified version of the panel or portion thereof, etc.), a sequence indicating an order in which the one or more views are to be presented, instructions for transitioning from one view to a subsequent view in the sequence (e.g., based on time, user input, etc.), instructions for presenting the one or more views (e.g., resolution, aspect ratio, brightness, color correction, accessibility controls such as text-to-speech or language translation, executable code, combinations thereof, or the like), combinations thereof, or the like.

The views may be defined to make the presentation of the graphical media more interactive, increase readability, satisfy user input or user preferences, etc. For example, a first view may be defined from a panel that corresponds to the portion of the panel where an action is occurring, and a second view may be defined that corresponds the portion of the panel including a character and a speech bubble include dialog spoken by the character. The views may be defined based on the content of a frame image and/or panel, semantic or contextual information derived by the first machine-learning model and/or the second machine-learning model, user input or user preferences, and/or the like.

User input or preferences may be used to control what views are defined to tailor the presentation to the graphical media to the user. The user preferences may be based on user input or from inference learning based on how the user interacts with this presentation or previous presentations. For example, if a user zooms into speech bubbles to read dialog, the computing device may generate views that are zoomed in on speech bubbles so that the user does not have to manually zoom in to read the graphical media. In another example, user input selection a subsequent view or eye tracking may be used to determine a read rate of the user, the read rate may be used to automatically transition to a subsequent view once enough time as passed that the user likely finished viewing the view.

The frame configuration may be a discrete package that can be executed by the computing or transmitted to another device for execution without additional instructions. Alternatively, or additionally, the frame configuration may be configured to execute within a particular environment or container such as a native application, a media player, a browser, or the like. For example, the frame configuration may include instructions that may be executed within an application installed on a mobile device to present the frame image of the graphical media.

The computing device may then facilitate execution of the frame configuration causing a presentation of a first view of the sequence of views. If the frame configuration is to be executed locally (e.g., by the computing device), the computing device may execute the frame configuration within a particular environment of the computing device (e.g., a native application, browser, etc. as previously described). If the graphical media is to be presented by another device (e.g., such as a user device, etc.), the computing device may transmit the frame configuration to the other device for execution within an environment of the other device. Alternatively, or additionally, the computing device may execute the frame configuration locally and stream the sequence of views to the other device. The computing device may receive an indication of user input at the other device and based on the input, control navigation of the sequence of views.

Graphical media may include a sequence of frame images that may be processed individually or in batches. In some instances, upon receiving a selection of a particular graphical media, the computing device may begin processing a first frame image (according to the aforementioned illustrative example) for presentation by the computing device or another device. While the computing device or other device is presenting the sequence of views of the first frame image, the computing device may begin processing a subsequent frame image of the sequence of frame images (according to the aforementioned illustrative example). The graphical media may be processed in real time as the interactive version of the graphical media is being presented. Alternatively, the sequence of frame images may be processed in a batch prior to selection for presentation such that frame configuration may be generated for each frame image of the sequence of frame images of a graphical media.

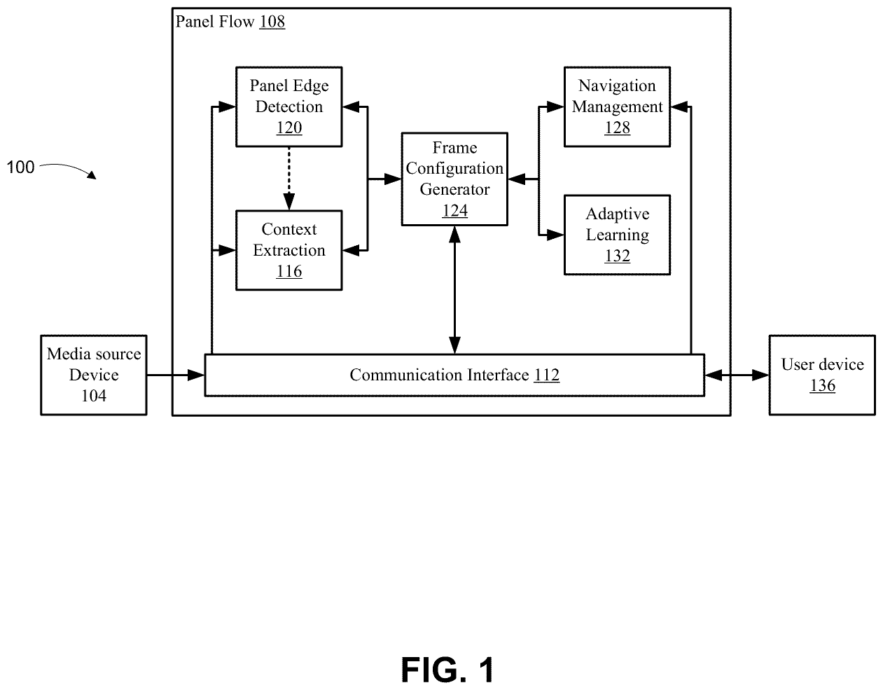

FIG. 1 illustrates a block diagram of example a panel flow system configured to generate frame configurations for interactive navigation of comic book frames according to aspects of the present disclosure. Panel flow system 100 may receive and process graphical media such comic books, graphical novels, books, etc. that comprise a combination of graphical content (e.g., illustrations, images, video, etc.) and text. Media source device 104 may be a device or system associated with an author, publisher, copyright holder, etc. of graphical media. Media source device 104 may transmit a representation of graphical media to panel flow 108 via communication interface 112. The representation of the graphical media may include a representation of a frame or a sequence of frames. In some instances, the representation of the graphical media may include images of the frames or pages of the graphical media. In other instances, the representation of the graphical media may include instructions that, when executed by panel flow 108, generate an instance of the graphical content.

The communication interface 112 route communications received from media source device 104 (and user device 136) to addressed components of panel flow 108. Upon receiving the frames of the representation of graphical media from media source device 104, communication interface 112 may pass the frames of the graphical media to panel to context extraction 116, panel edge detection 120, and frame configuration generator 124. Context extraction 116 may include one or more machine-learning models configured to extract context information from alphanumeric text appearing in the frame such as narration, speech bubbles, onomatopoeia, and/or other text. In some instances, the one or more machine-learning models may be configured to perform optical character recognition (OCR) to extract text from other portions of the frame. In other instances, the text may be extracted by panel edge detection 120 and passed to context extraction 116 for processing.

The one or more machine-learning models of context extraction 116 may include, but are not limited to, transformers (generative pre-trained transformers (GPT), Bidirectional Encoder Representations from Transformers (BERTs), text-to-text-transfer-transformer (T5), or the like), generative adversarial networks (GANs), recurrent neural networks (e.g., long short-term memory (LSTM), etc.), recurrent gated units (GRUs), combinations thereof, or the like. The one or more machine-learning models of context extraction 116 may be trained by panel flow 108 or by another device using general graphical media or for particular types of graphical media. For example, panel flow 108 (or the other device) may aggregate text extracted from graphical media and segment the text based on the type of graphical media that the is extracted from. Panel flow 108 may then define training datasets from the text corresponding to a particular graphical media type to train the one or more machine-learning models for the particular graphical media type or alternatively, train the one or more machine-learning models using general training data including multiple graphical media types. The training data may be annotated to increase training of the one or more machine-learning models. The annotations may include additional data types, labels, metadata, derived or reduced data aspects of the training data (e.g., such as through a regression algorithm, principal component analysis, etc.), combinations thereof, or the like. Panel flow 108 (or another device) may train the one or more machine-learning models using unsupervised, supervised, self-supervised, reinforcement (for post training learning) and/or transfer learning. The one or more machine-learning models may be trained for a predetermined time interval, predetermined quantity of iterations, and/or until one or more accuracy metrics are reached (e.g., such as, but not limited to, accuracy, precision, area under the curve, logarithmic loss, F1 score, mean absolute error, mean square error, or the like).

The text may be translated into a feature vector (e.g., an ordered or unordered set of set of features) for input into the one or more machine-learning models. The output of the one or more machine-learning models may include contextual information of particular portion of text, a panel, and/or a frame such as, but not limited to, an action occurring in a panel, an overall mean or context of a panel, meaning or context of particular portions of text, an identification of a character associated with particular portions of text, and/or the like. In some instances, the output may include a confidence value indicative of degree in which the output of the one or more machine-learning models fits the input feature vector. The confidence value may be used to select a particular output (if more than one output is generated) or discard an output that may not be usable. The extracted text, the output from the one or more machine-learning models, and/or the confidence value may be passed to frame configuration generator 124 for further processing.

Panel edge detection 120 may be configured to process the graphical component of the frame to identify panels, extract text (if not extracted by context extraction 116), perform image segmentation to distinguish component parts of a frame, perform object detection to identify characters, objects, backgrounds, foregrounds, speech bubbles, onomatopoeia, and/or the like. The one or more machine-learning models may include, but are not limited to, neural networks (e.g., such as recurrent neural networks, mask recurrent neural networks, convolutional neural networks, faster convolutional neural networks, etc.), you only look once (YOLO), EfficientDet, deep learning networks, combinations thereof, or the like. The one or more machine-learning models of panel edge detection 120 may be trained by panel flow 108 or by another device using general graphical media or for particular types of graphical media. For example, panel flow 108 (or the other device) may aggregate graphical media, frames, and/or panels from graphical media and segment the graphical media, frames, and/or panels based on the type of graphical media the graphical media, frames, and/or panels were extracted from. Panel flow 108 may then define training datasets from the graphical media, frames, and/or panels corresponding to a particular graphical media type to train the one or more machine-learning models for the particular graphical media type or alternatively, train the one or more machine-learning models using general training data corresponding to multiple graphical media types. The training data may be annotated to increase training of the one or more machine-learning models. The annotations may include additional data types, labels, metadata, derived or reduced data aspects of the training data (e.g., such as through a regression algorithm, principal component analysis, etc.), combinations thereof, or the like. Panel flow 108 (or another device) may train the one or more machine-learning models using unsupervised, supervised, self-supervised, reinforcement (for post training learning) and/or transfer learning. The one or more machine-learning models may be trained for a predetermined time interval, predetermined quantity of iterations, and/or until one or more accuracy metrics are reached (e.g., such as, but not limited to, accuracy, precision, area under the curve, logarithmic loss, F1 score, mean absolute error, mean square error, or the like).

The output of the one or more machine-learning models of panel edge detection 120 may include an identification of the portions of the frame that correspond to a panel, character, objects, etc. (e.g., boundary boxes, pixel locations, etc.), an identification of particular objects depicted in a frame or panel, an identification of an action depicted in a frame or panel, an indication of a sentiment or context of a frame or panel, combinations thereof, or the like. In some instances, the output from the one or more machine-learning models may include modified frames, panels, or portions thereof such as highlighted portions of a frame or panel (e.g., of a particular character, text, etc.), blurring of background or foreground, color correction (e.g., for highlighting, sharpness, color blindness, etc.), extracted portions of the a frame or panel (e.g., such as the portions corresponding to particular characters, actions, speech bubbles, text objects, clothing, etc.), combinations thereof, or the like. The output from the one or more machine-learning models may be passed to frame configuration generator 124 for further processing. In some instances, panel edge detection 120 may pass extracted text to context extraction 116.

Navigation management 128 may define navigation operations usable to transition between frames, panels, or views of the graphical media. The navigation operations may include, but are not limited to time (e.g., such as a time interval lapsing, etc.) or input (e.g., such as, but not limited to, device input such as from a keyboard or mouse or other input device, gesture from a touch interface, eye tracking from a camera, voice commands from a microphone, movement such as shaking or turning or the like of the presentation device, combinations thereof, or the like). The navigation operations may combine time and/or different inputs to enable different forms of navigation for example eye tracking may be used to determine when a user has finished reading a panel or view and a gesture (e.g., such as tap or swipe) may be used to return to a previous panel or view. The navigation operations may be selected based on the capabilities of the presentation device (e.g., such as the presence or absence of a touch interface, camera, microphone, etc.), user input, user preferences, or the like. User preferences may be based on user input and inferred preferences from adaptive learning 132. Navigation management 128 may transmit instructions to frame configuration generator to embed instructions for executing navigation operations within frame configurations. Alternatively, or additionally, navigation management 128 may monitor communication interface 112 for input from a connected device or communications form user device 136 indicative of input being received. Navigation management 128 may then execute a navigation operation causing to transition to a new (or previous) panel or frame.

Adaptive learning 132 may receive characteristics from a presentation of graphical media and frame configurations and use machine-learning models to predict parameters that modify a presentation of graphical media or frame configuration to may improve subsequent presentation of graphical media or frame configurations for a particular user. For example, adaptive learning 132 may learn a user's specific voice commands and preferences, reading rate (e.g., based on quantity of words, language, graphical content of a panel, etc.) for automatic transition between panels or views, preferred image size for reading text or viewing the content of panels, or the like. The predicted parameters may be implemented during a subsequent presentation of graphical media. If the user reverts a modification implemented by a predictive parameter by adaptive learning 132, then that parameter may be removed to prevent the modification from occurring again. Adaptive learning 132 may operate in a background process during presentation of graphical media or execution of a frame configuration. Alternatively, or additionally, adaptive learning 132 may receive characteristics of a presentation of graphical media or a frame configuration during or after the presentation of graphical media or a frame configuration. Predicted parameters may be passed to frame configuration generator 124 for implementation into the frame configuration. Alternately or additionally, if the graphical media or frame configuration is presented by panel flow 108, then adaptive learning 132 may implement the predicted parameters in real time (e.g., during presentation of graphical media or a frame configuration) or for subsequent graphical media or a frame configuration.

Frame configuration generator 124 may use the output from panel edge detection 120, context extraction 116, navigation management 128 and adaptive learning 132 to generate a frame configuration that defines presentation of the frame (or graphical media). The frame configuration may include a sequence of views with view corresponding to a frame, a panel, or a portion thereof. The views may be defined based on the context of the frame or panel (e.g., from panel edge detection 120 and/or context extraction 116), adaptive learning 132, and/or the like. The sequence of views may present the frame in order (e.g., such as the order depicted by the frame, panels of the frame, and/or text or dialog of a panel) or out of order. For example, a user may request to read a frame in temporal order rather than the order presented. Upon analyzing the context of the frame, the second panel of the frame may be presented before the first panel of the frame because the semantic/contextual analysis of the panels may indicate that the second panel includes content that occurred before the first panel in the relative time of the narrative.

The frame configuration can be packaged for execution within an application, a browser (e.g., web browser, or the like), or as a stand-alone process. The frame configuration may be executed by panel flow 108 or passed to user device 136 through communication interface 112. For example, user device 136 may request an interactive version of a particular graphical media. Panel flow 108 may generate a frame configuration of a first frame, one or more frames, or the frames of the particular graphical media and transmit the frame configuration to user device 136 for presentation. If additional frame configurations are needed (e.g., of subsequent frames of the particular graphical media), then the additional frame configurations may be transmitted as they are generated or upon request by user device 136.

During presentation of the graphical media or frame configuration and/or after presentation of the graphical media or frame configuration, characteristics of the presentation may be captured and used to optimize operations of panel flow 108 such as reinforcement learning or retraining of machine-learning models, updating user preferences or settings, generating new predictions by adaptive learning 132, etc. The characteristics may be usable to adjust weights, hyperparameters, training phases, training data, output selection (e.g., confidence selection, etc.), feature selection, etc. to improve operations of panel flow 108 and improve customization of frame configurations for particular users.

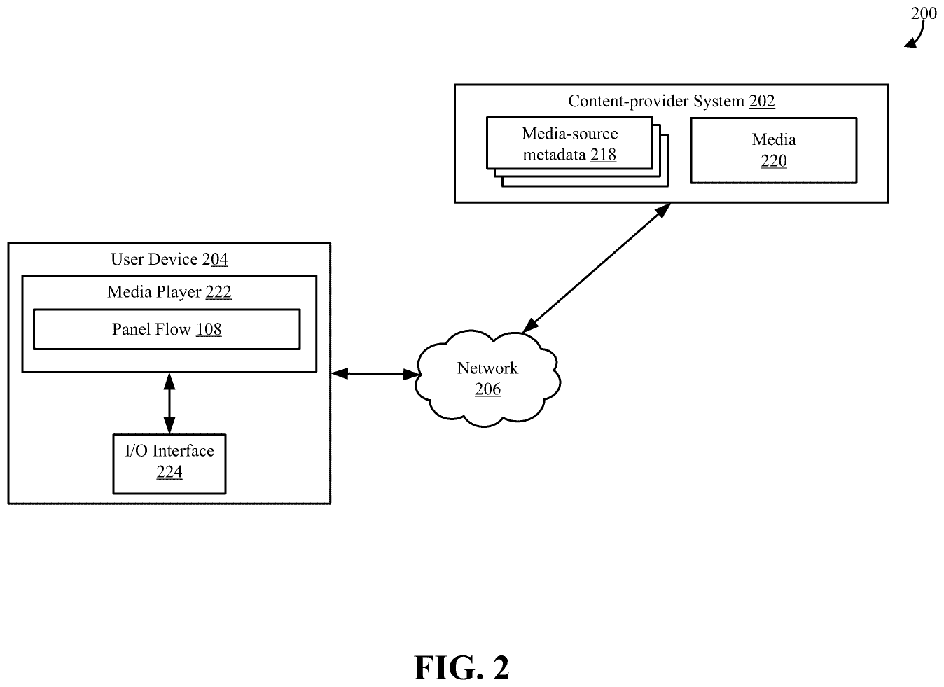

FIG. 2 illustrates a block diagram of an example panel flow system that generates local frame configurations for interactive navigation of comic book frames by mobile devices according to aspects of the present disclosure. Panel flow system 200 includes an implementation of panel flow 108 (as described in connection to FIG. 1) that operates within an environment of a user device (e.g., user device 204). User device 204 may be a computer (e.g., desktop, laptop computer), mobile device (e.g., smartphone, tablet, e-reader, etc.), display device (e.g., television, monitor, etc.), or the like. User device 204 may include processing hardware (e.g., central processing unit, graphical processing unit, volatile and/or non-volatile memories, input/output interfaces, network interfaces, etc.) to enable execution of panel flow 108, software, and/or the like. User device 204 may receive input from one or more input/output devices through I/O interface 224. Example input/output devices include, but are not limited to, a keyboard and/or mouse, camera (e.g., for eye tracking, gestures, etc.), touch interface (e.g., capacitive touchscreen, or the like for touch-based gestures, etc.), motion sensors (e.g., accelerometers, gyroscopes, etc. configured to measure motion in one or more axes), a microphone (e.g., for speech recognition and voice commands, etc.), a display, and/or the like. Different user devices may include different input/output devices. The particular input/output devices included in a user device may depend on the user device type. For instance, a mobile device such as a smartphone may include a camera, touch interface, motion sensors, etc. but exclude a keyboard or mouse. A desktop computer may include a keyboard and mouse but exclude a touch interface and motion sensors. Panel flow 108 may operate based on the particular input/output devices available to a particular user device.

In some instances, panel flow 108 may be implemented as a software component that may be executed by media player 222 or as a separate service of user device 204. In other instances, panel flow 108 may be implemented as a hardware component such as an application-specific integrated circuit, field programmable gate array, mask programmable gate array, or as set of interconnected components (e.g., such as central processors, graphical processing units, memory, etc.), that operate in collaboration with the processing components of user device 208 to execute operations. For instance, the hardware component may include a thread scheduler that selects the processing of instructions to user device 204 or the hardware components to improve the processing speeds and/or consumption of processing resources. For instances, the hardware component may offload machine-learning processes to a graphics processing unit of user device 204, which may more efficiently execute the processes and execute other processes internally. If a processing bottleneck occurs, the hardware component may adaptively route execution of processes to the central processing unit of user device 204 until the processing bottleneck is alleviated. The hardware component may operate as a specialized processing device that may operate within another processing device and selective use the processing resources of the other processing device for improved operation of the hardware component.

Content-provider system 202 may store graphical media 220 and media-source metadata 218 associated with graphical media 220. Graphical media 220 may be generated by content-provider system 202 or aggregated by content-provider system 202 for distribution to user devices 204. User device 204 may transmit a request for graphical media through network 206 and in response, content-provider system 202 may transmit the request graphical media to user device 204 (or cause the graphical media to be transmitted to user device 204 if not stored locally be content-provider system 202). Media-source metadata 218 stores metadata associated with graphical media. The metadata may include information associate with the creation of the metadata (e.g., author, publishing date, location, etc.), information about the characters or narrative of the graphical media, technical information (e.g., such as file types, file sizes, image resolution, aspect ratios, color information, etc.), features that may be usable machine-learning models of panel flow 108, and/or the like. The metadata may be transmitted with graphical media requested by user device 204 to improve processing of the graphical media and generation of frame configurations.

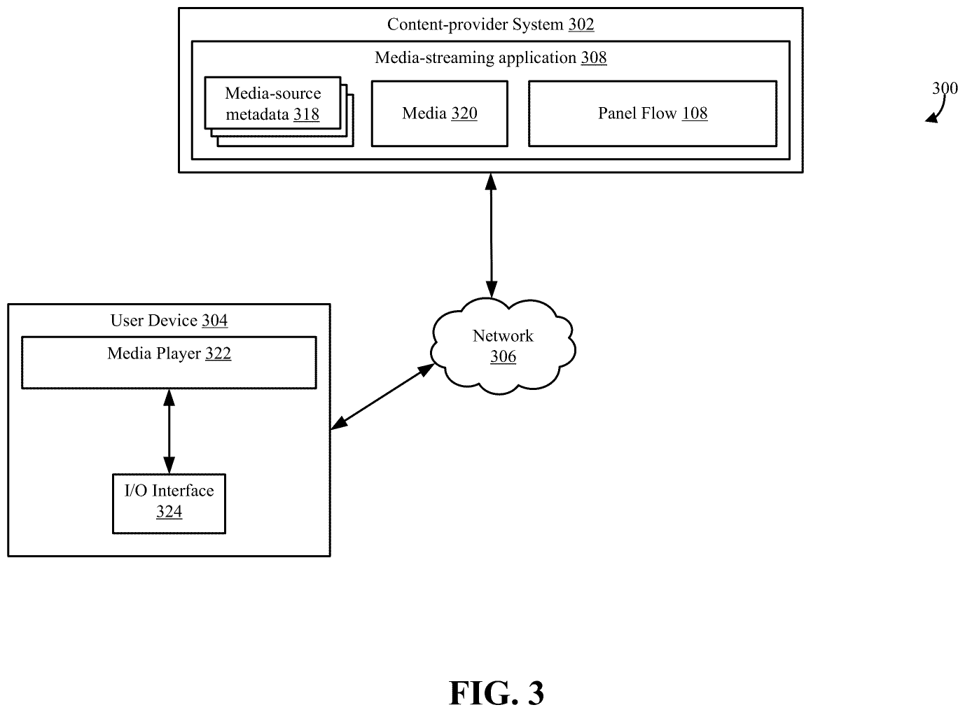

FIG. 3 illustrates a block diagram of an example panel flow system configured to stream frame configurations to remote devices for interactive navigation of comic book frames according to aspects of the present disclosure. Panel flow system 300 includes an implementation of panel flow 108 (as described in connection to FIG. 1) that operates within a remote environment (e.g., content-provider system 302). User device 304 may be a computer (e.g., desktop, laptop computer), mobile device (e.g., smartphone, tablet, e-reader, etc.), display device (e.g., television, monitor, etc.), or the like. User device 304 may include processing hardware (e.g., central processing unit, graphical processing unit, volatile and/or non-volatile memories, input/output interfaces, network interfaces, etc.) to enable presentation of graphical media (e.g., via media player 322 or another application). User device 204 may receive input from one or more input/output devices through I/O interface 224. Example input/output devices include, but are not limited to, a keyboard and/or mouse, camera (e.g., for eye tracking, gestures, etc.), touch interface (e.g., capacitive touchscreen, or the like for touch-based gestures, etc.), motion sensors (e.g., accelerometers, gyroscopes, etc. configured to measure motion in one or more axes), a microphone (e.g., for speech recognition and voice commands, etc.), a display, and/or the like. Different user devices may include different input/output devices. The particular input/output devices included in a user device may depend on the user device type. For instance, a mobile device such as a smartphone may include a camera, touch interface, motion sensors, etc. but exclude a keyboard or mouse. A desktop computer may include a keyboard and mouse but exclude a touch interface and motion sensors.

Content-provider system 302 may store graphical media 320, media-source metadata 318 associated with graphical media 320 and an instance of panel flow 108. Graphical media 320 may be generated by content-provider system 302 or received by content-provider system 302 for distribution to user devices 304. User device 304 may transmit a request for graphical media through network 306 and in response, content-provider system 202 may transmit the request graphical media to user device 304 (or cause the graphical media to be transmitted to user device 304 if not stored locally be content-provider system 304). Media-source metadata 318 may store metadata associated with graphical media. The metadata may include information associate with the creation of the metadata (e.g., author, publishing date, location, etc.), information about the characters or narrative of the graphical media, technical information (e.g., such as file types, file sizes, image resolution, aspect ratios, color information, etc.), features that may be usable machine-learning models of panel flow 108, and/or the like. The metadata may be transmitted with graphical media requested by user device 304 to improve processing of the graphical media and generation of frame configurations.

In some instances, panel flow 108 may be implemented as a software component that may be executed by media-streaming application 308 or as a separate service of user device 304. In other instances, panel flow 108 may be implemented as a hardware component such as an application-specific integrated circuit, field programmable gate array, mask programmable gate array, or as set of interconnected components (e.g., such as central processors, graphical processing units, memory, etc.), that operate in collaboration with the processing components of user device 208 to execute operations. For instance, the hardware component may include a thread scheduler that selects the processing of instructions to content-provider system 302 or the hardware components to improve the processing speeds and/or consumption of processing resources. For instances, the hardware component may offload machine-learning processes to a graphics processing unit of content-provider system 302, which may more efficiently execute the processes and execute other processes internally. If a processing bottleneck occurs, the hardware component may adaptively route execution of processes to the central processing unit of content-provider system 302 until the processing bottleneck is alleviated. The hardware component may operate as a specialized processing device that may operate within another processing device and selective use the processing resources of the other processing device for improved operation of the hardware component.

Panel flow 108 may be configured to generate frame configurations for execution by user device 304 or stream frame configurations to user device 304. For example, user device 304 may request a frame configuration of graphical media for presentation by user device 304. If user device 304 includes sufficient processing resources and/or software to execute the frame configuration (e.g., as determined by user device 304, by content-provider system 302 through an assessment of the processing capabilities and/or input/output devices of user device 304, based on user input, etc.), then content-provider system 302 may transmit the frame configuration generated by panel flow 108 that corresponds to the requested graphical media to user device 304 through network 306. If user device 304 does not include sufficient processing resources and/or software to execute the frame configuration, then content-provider may stream the frame configuration to user device 304 via media player 322, a browser, or other application of user device 304. In a streaming configuration, when user input is received by user device 304, user device 304 may transmit an identification of the user input to content-provider system 302 for implementation (e.g., such as changing user preferences, implementing navigation operations, modifying navigation operations, etc.).

Panel flow 108 may generate frame configurations upon request by user device 304 (e.g., in real time) or panel flow 108 may pre-generate and store frame configurations for later transmission to user devices. Upon request by a user, panel flow may implement the customizations associated with a user of the requesting user device (e.g., such as particular views, view sequences, adaptive learning parameters, navigation operations, etc.).

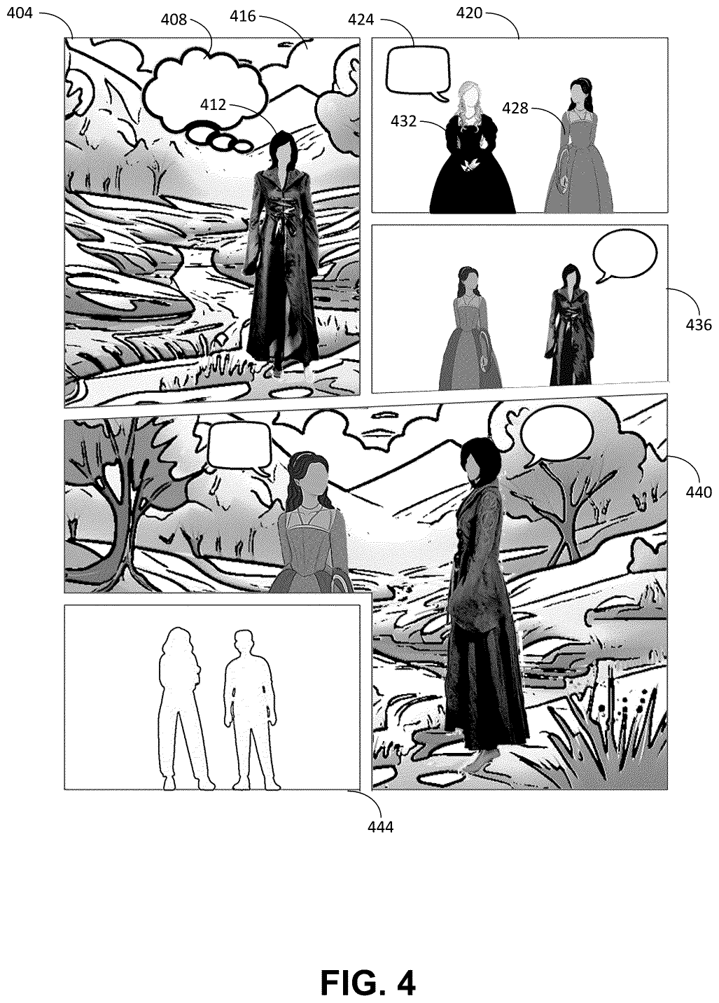

FIG. 4 illustrates an example frame image comprising one or more panels according to aspects of the present. A comic book may include a sequence of frame images with each frame image (such as the example frame image shown) including panels that represent portions of a narrative of the comic book. The panels may be read in a particular sequence that can be identified based on reading conventions (e.g., right to left in western media, right to left for some eastern media such as manga, etc.), speech bubbles, the graphical component of a panel, panel identifiers (if present), etc. A panel edge detection component (e.g., panel edge detection 120), may extract context information such as identifying individual panels (e.g., panels 404, 420, 436, 440, 444, etc.), components of a panel, a reading order of panels, etc. For example, the panel edge detection component may identify panel 404 as being a distinct panel from other panels of the frame image (such as panel 420, etc.), speech bubble 408, characters 412, background 416, etc. The panel edge detection component may also identify the component parts of panel 420 such speech bubble 424, characters 428 and 432, as well as the component parts of other panels in the frame image. The component parts may be used by context extraction (e.g., context extraction 116) to identify additional context information such as sematic meaning of a panel, a sentiment or mood of a panel, a reading order of the panels, etc.

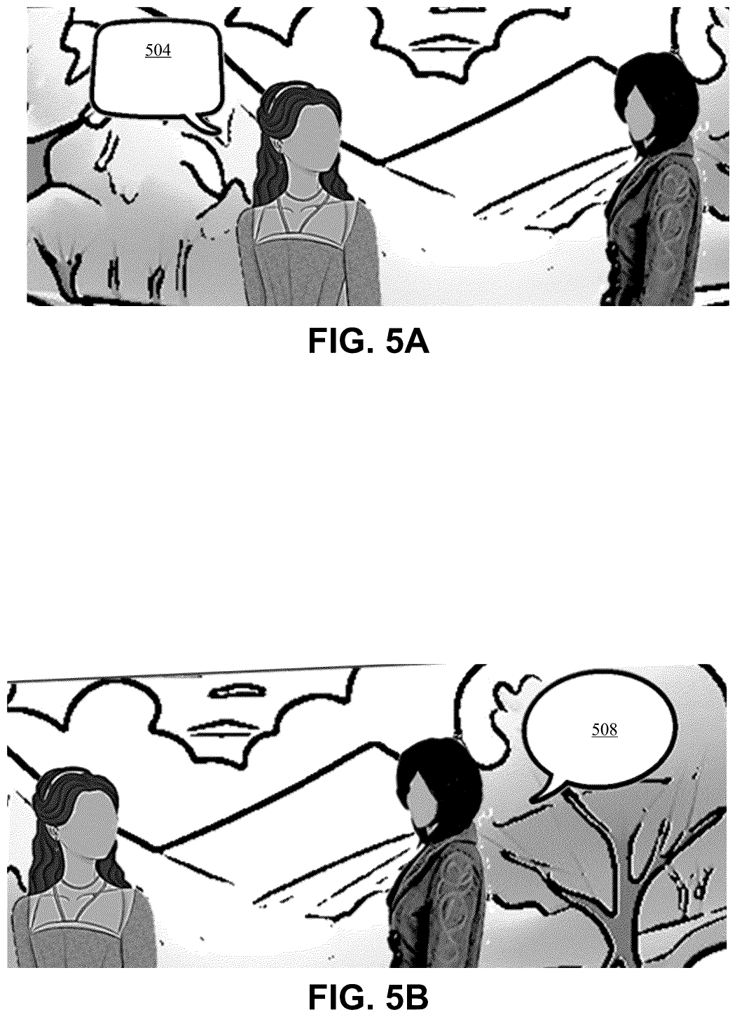

The component parts of the frame image and derived context information (e.g., panel order, semantic meaning, sentiment, etc.) may be used to generate a frame configuration that provide an interactive presentation of the frame image. The frame configuration may include a sequence of views. A view may be the frame image (as a whole), a panel, a portion of a panel, a modified version of a panel, etc. based on the context information, user preferences, or adaptive learning as shown in FIGS. 5A and 5B.

FIGS. 5A and 5B illustrate example views generated by a panel flow system from a frame image according to aspects of the present. FIG. 5A illustrates an example view derived from panel 440 of FIG. 4. Panel 440 includes a graphical depiction of dialog between two characters of the narrative. To emphasize the sentiment of the panel, a first view may be derived that includes a zoomed in or expanded representation of a first character and corresponding speech bubble (as shown in FIG. 5A) and a second view may be derived that includes a zoomed in or expanded representation of a second character and corresponding speech bubble (as shown in FIG. 5B). The views may be presented in the sequence shown (e.g., FIG. 5A then FIG. 5B) based on an inference that the text of speech bubble 504 comes before the text of speech bubble 508 (e.g., as determined by context extraction, user input, etc.).

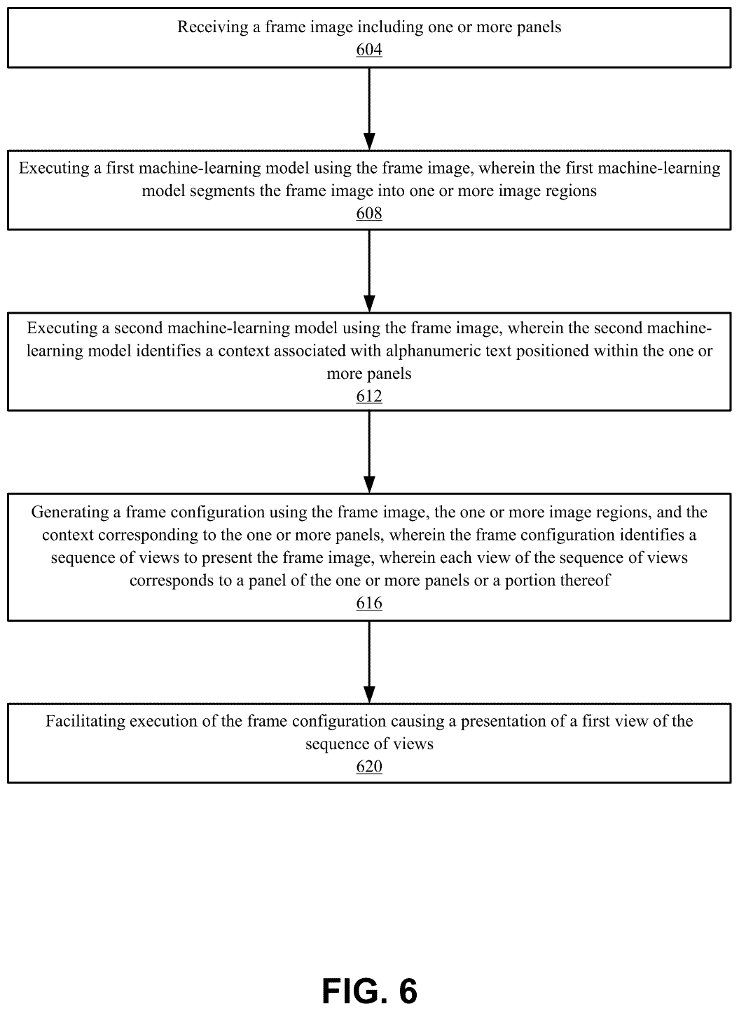

FIG. 6 illustrates a flowchart of an example process of interactive navigation of comic book frames using contextual text analysis and machine-learning according to aspects of the present disclosure. At block 604, a computing device may receive receiving a frame image including one or more panels. The frame image may be an image of one or more pages of graphical media in which each panel of the one or more panels corresponds to a portion of a narrative that includes graphical and textual elements. The computing device may be configured to process frame images to translate the graphical media into an interactive format with improved readability, accessibility, and customization.

At block 608, the computing device may execute a first machine-learning model using the frame image. The first machine-learning model may be trained to process the graphical component of the frame image such as, but not limited to, image segmentation, edge detection, object and/or character identification, context classification, and/or the like. The first machine-learning model may include, but is not limited to, neural networks (e.g., such as recurrent neural networks, mask recurrent neural networks, convolutional neural networks, faster convolutional neural networks, etc.), you only look once (YOLO), EfficientDet, deep learning networks, combinations thereof, or the like. The first machine-learning model may be a single machine-learning model or an ensemble model (e.g., two or more machine-learning models). The computing device (or another device) may train the first machine-learning model using unsupervised, supervised, self-supervised, and/or transfer learning from training data including a set of frame images derived from graphical media.

At block 612, the computing device may execute a second machine-learning model using the frame image to derive contextual information associated with text and/or onomatopoeia within the frame image. The second machine-learning model maybe trained to perform semantic analysis (e.g., derive a meaning of words and phrases), determine a topic of a panel or frame image, determine a mood or sentiment of a panel or frame image, associate a character of a frame image or panel with a portion of text (e.g., such as dialog spoken by the character, narration related to the character, etc.), derive an a sequence in which the dialog is intended to be read, identify an action depicted within a frame image or panel, associate the action with a character, combinations thereof, or the like. The second machine-learning model may include, but is not limited to, transformers (generative pre-trained transformers (GPT), Bidirectional Encoder Representations from Transformers (BERTs), text-to-text-transfer-transformer (T5), or the like), generative adversarial networks (GANs), recurrent neural networks (e.g., long short-term memory (LSTM), etc.), recurrent gated units (GRUs), combinations thereof, or the like. The second machine-learning model may be a single machine-learning model or an ensemble model (e.g., two or more machine-learning models). The computing device (or another device) may train the second machine-learning model using unsupervised, supervised, self-supervised, and/or transfer learning from training data including text and onomatopoeia extracted from graphical media.

At block 616, the computing device may generate a frame configuration using the frame image, the one or more image regions, and the context corresponding to the one or more panels. A frame configuration may include an identification of one or more views of the frame image (e.g., such as, but not limited to, the frame image, a panel of the frame image, a portion of a panel, a modified version of the panel or portion thereof, etc.), a sequence indicating an order in which the one or more views are to be presented, instructions for transitioning from one view to a subsequent view in the sequence (e.g., based on time, user input, etc.), instructions for presenting the one or more views (e.g., resolution, aspect ratio, brightness, color correction, accessibility controls such as text-to-speech or language translation, executable code, combinations thereof, or the like), combinations thereof, or the like.

The views may be defined to make the presentation of the graphical media more interactive, increase readability, satisfy user input or user preferences, etc. For example, a first view may be defined from a panel that corresponds to the portion of the panel where an action is occurring, and a second view may be defined that corresponds the portion of the panel including a character and a speech bubble include dialog spoken by the character. The views may be defined based on the content of a frame image and/or panel, semantic or contextual information derived by the first machine-learning model and/or the second machine-learning model, user input or user preferences, and/or the like.

User input or preferences may be used to control what views are defined to tailor the presentation to the graphical media to the user. The user preferences may be based on user input or from inference learning based on how the user interacts with this presentation or previous presentations. For example, if a user zooms into speech bubbles to read dialog, the computing device may generate views that are zoomed in on speech bubbles so that the user does not have to manually zoom in to read the graphical media. In another example, user input selection a subsequent view or eye tracking may be used to determine a read rate of the user, the read rate may be used to automatically transition to a subsequent view once enough time as passed that the user likely finished viewing the view.

The frame configuration may be a discrete package that can be executed by the computing or transmitted to another device for execution without additional instructions. Alternatively, or additionally, the frame configuration may be configured to execute within a particular environment or container such as a native application, a media player, a browser, or the like. For example, the frame configuration may include instructions that may be executed within an application installed on a mobile device to present the frame image of the graphical media.

In some instances, the frame configuration may be augmented based on adaptive learning and/or user preferences. For instance, eye tracking may be implemented to determine when a user is finished view (and/or reading) a particular view and causing a transition to a subsequent view. Alternatively, a viewing or reading rate may be defined based on the content of the view (e.g., quantity of words, complexity of the panel, sentiment of the panel, etc.) and an average rate in which a user transitions to a subsequent view. The viewing rate or reading rate may be used to define a timer to automatically transition to a subsequent view. Accessibility functions may also be implemented such as text-to-speech (e.g., using machine-learning speech generation for character-specific voices, and narration, etc.), modified views, highlighted aspects of panels such as a character that is speaking, color correction (e.g., for improved readability for users with color blindness or other optical conditions), text translations (e.g., into a language selected by a user), voice controls, etc. The frame configuration may include adaptive learning that can modify the presentation of the frame configuration in real time. For example, adaptive learning may be used to adjust the transition rate to new views, increase the size of views or text for increased readability and semantic effect, etc.

At block 620, the computing device may facilitate execution of the frame configuration causing a presentation of a first view of the sequence of views. If the frame configuration is to be executed locally (e.g., by the computing device), the computing device may execute the frame configuration within a particular environment of the computing device (e.g., a native application, browser, etc. as previously described). If the graphical media is to be presented by another device (e.g., such as a user device, etc.), the computing device may transmit the frame configuration to the other device for execution within an environment of the other device. Alternatively, or additionally, the computing device may execute the frame configuration locally and stream the sequence of views to the other device. The computing device may receive an indication of user input at the other device and based on the input, control navigation of the sequence of views.

Graphical media may include a sequence of frame images that may be processed individually or in batches. In some instances, upon receiving a selection of a particular graphical media, the computing device may begin processing a first frame image (according to the aforementioned illustrative example) for presentation by the computing device or another device. While the computing device or other device is presenting the sequence of views of the first frame image, the computing device may begin processing a subsequent frame image of the sequence of frame images (according to the aforementioned illustrative example). The graphical media may be processed in real time as the interactive version of the graphical media is being presented. Alternatively, the sequence of frame images may be processed in a batch prior to selection for presentation such that frame configuration may be generated for each frame image of the sequence of frame images of a graphical media.

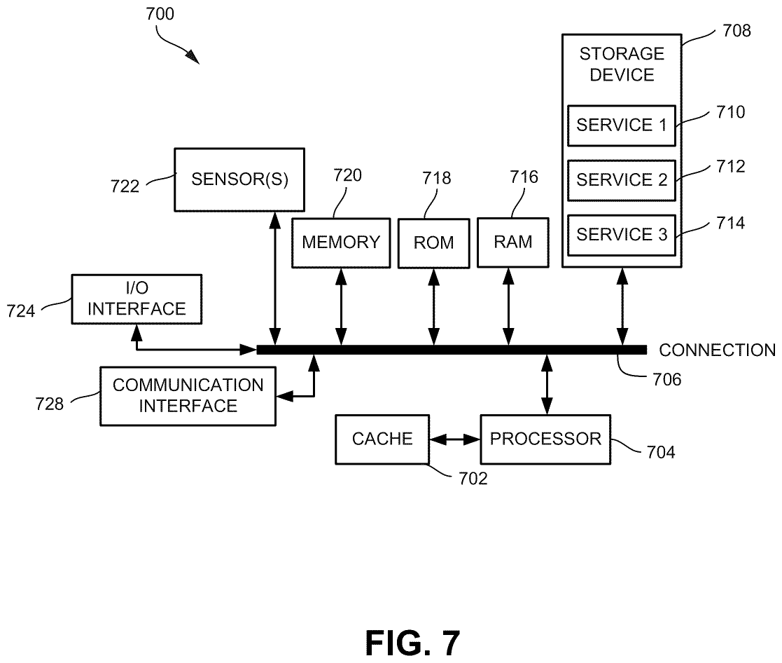

FIG. 7 illustrates an example computing device according to aspects of the present disclosure. For example, computing device 700 can implement any of the systems or methods described herein. In some instances, computing device 700 may be a component of or included within a media device. The components of computing device 700 are shown in electrical communication with each other using connection 706, such as a bus. The example computing device architecture 700 includes a processor (e.g., CPU, processor, or the like) 704 and connection 706 (e.g., such as a bus, or the like) that is configured to couple components of computing device 700 such as, but not limited to, memory 720, read only memory (ROM) 718, random access memory (RAM) 716, and/or storage device 708, to processing unit 710.

Computing device 700 can include a cache 702 of high-speed memory connected directly with, in close proximity to, or integrated within processor 704. Computing device 700 can copy data from memory 720 and/or storage device 708 to cache 702 for quicker access by processor 704. In this way, cache 702 may provide a performance boost that avoids delays while processor 704 waits for data. Alternatively, processor 704 may access data directly from memory 720, ROM 717, RAM 716, and/or storage device 708. Memory 720 can include multiple types of homogenous or heterogeneous memory (e.g., such as, but not limited to, magnetic, optical, solid-state, etc.).

Storage device 708 may include one or more non-transitory computer-readable media such as volatile and/or non-volatile memories. A non-transitory computer-readable medium can store instructions and/or data accessible by computing device 700. Non-transitory computer-readable media can include, but is not limited to magnetic cassettes, hard-disk drives (HDD), flash memory, solid state memory devices, digital versatile disks, cartridges, compact discs, random access memories (RAMs) 725, read only memory (ROM) 720, combinations thereof, or the like.

Storage device 708, may store one or more services, such as service 1 710, service 2 712, and service 3 714, that are executable by processor 704 and/or other electronic hardware. The one or more services include instructions executable by processor 704 to: perform operations such as any of the techniques, steps, processes, blocks, and/or operations described herein (such as the operations of FIG. 6); control the operations of a device in communication with computing device 700; control the operations of processing unit 710 and/or any special-purpose processors; combinations therefor; or the like. Processor 704 may be a system on a chip (SOC) that includes one or more cores or processors, a bus, memories, clock, memory controller, cache, other processor components, and/or the like. A multi-core processor may be symmetric or asymmetric.

Computing device 700 may include one or more input devices 722 that may represent any number of input mechanisms, such as a microphone, a touch-sensitive screen for graphical input, keyboard, mouse, motion input, speech, media devices, sensors, combinations thereof, or the like. Computing device 700 may include one or more output devices 724 that output data to a user. Such output devices 724 may include, but are not limited to, a media device, projector, television, speakers, combinations thereof, or the like. In some instances, multimodal computing devices can enable a user to provide multiple types of input to communicate with computing device 700. Communications interface 726 may be configured to manage user input and computing device output. Communications interface 726 may also be configured to managing communications with remote devices (e.g., establishing connection, receiving/transmitting communications, etc.) over one or more communication protocols and/or over one or more communication media (e.g., wired, wireless, etc.).

Computing device 700 is not limited to the components as shown if FIG. 7. Computing device 700 may include other components not shown and/or components shown may be omitted.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored in a form that excludes carrier waves and/or electronic signals. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Some portions of this description describe examples in terms of algorithms and symbolic representations of operations on information. These operations, while described functionally, computationally, or logically, may be implemented by computer programs or equivalent electrical circuits, microcode, or the like. Furthermore, arrangements of operations may be referred to as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module can be implemented with a computer-readable medium storing computer program code, which can be executed by a processor for performing any or all of the steps, operations, or processes described.

Some examples may relate to an apparatus or system for performing any or all of the steps, operations, or processes described. The apparatus or system may be specially constructed for the required purposes, and/or it may comprise a general-purpose computing device selectively activated or reconfigured by a computer program stored in memory of computing device. The memory may be or include a non-transitory, tangible computer readable storage medium, or any type of media suitable for storing electronic instructions, which may be coupled to a bus. Furthermore, any computing systems referred to in the specification may include a single processor or multiple processors.

While the present subject matter has been described in detail with respect to specific examples, it will be appreciated that those skilled in the art, upon attaining an understanding of the foregoing, may readily produce alterations to, variations of, and equivalents to such embodiments. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art.

For clarity of explanation, in some instances the present disclosure may be presented as including individual functional blocks including functional blocks comprising devices, device components, steps or routines in a method embodied in software, or combinations of hardware and software. Additional functional blocks may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual examples may be described herein as a process or method which may be depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but may have additional steps not shown. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

Devices implementing the methods and systems described herein can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. The program code may be executed by a processor, which may include one or more processors, such as, but not limited to, one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A processor may be a microprocessor; conventional processor, controller, microcontroller, state machine, or the like. A processor may also be implemented as a combination of computing components (e.g., a combination of a DSP and a microprocessor, a plurality of microprocessors, one or more microprocessors in conjunction with a DSP core, or any other such configuration). Accordingly, the term “processor,” as used herein may refer to any of the foregoing structure, any combination of the foregoing structure, or any other structure or apparatus suitable for implementation of the techniques described herein. Functionality described herein also can be embodied in peripherals or add-in cards. Such functionality can also be implemented on a circuit board among different chips or different processes executing in a single device, by way of further example.

In the foregoing description, aspects of the disclosure are described with reference to specific examples thereof, but those skilled in the art will recognize that the disclosure is not limited thereto. Thus, while illustrative examples of the disclosure have been described in detail herein, it is to be understood that the inventive concepts may be otherwise variously embodied and employed, and that the appended claims are intended to be construed to include such variations. Various features and aspects of the above-described disclosure may be used individually or in any combination. Further, examples can be utilized in any number of environments and applications beyond those described herein without departing from the broader spirit and scope of the disclosure. The disclosure and figures are, accordingly, to be regarded as illustrative rather than restrictive.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or media devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

1. A method comprising:
receiving a frame image including one or more panels;
executing a first machine-learning model using the frame image, wherein the first machine-learning model segments the frame image into one or more image regions;
executing a second machine-learning model using the frame image, wherein the second machine-learning model identifies a context associated with alphanumeric text positioned within the one or more panels;
generating a frame configuration using the frame image, the one or more image regions, and the context corresponding to the one or more panels, wherein the frame configuration identifies a sequence of views to present the frame image, wherein each view of the sequence of views corresponds to a panel of the one or more panels or a portion thereof; and
facilitating execution of the frame configuration causing a presentation of a first view of the sequence of views.

2. The method of claim 1, wherein the first machine-learning model performs edge detection to identify each panel of the one or more panels.

3. The method of claim 1, wherein the first machine-learning model uses the one or more image regions to determine a presentation order of the one or more panels.

4. The method of claim 1, wherein the second machine-learning model uses the context corresponding to the alphanumeric text to define a presentation order of the one or more panels.

5. The method of claim 1, further comprising:
detecting a navigation command associated with the presentation of a first view of the sequence of views; and
presenting a subsequent view of the sequence of views based on the navigation command.

6. The method of claim 5, wherein the navigation command is defined based on one of: a voice command, a gesture, device motion, eye movement, device input, or time.

7. The method of claim 5, further comprising:
modifying the frame configuration based on the navigation command, wherein modifying the frame configuration includes adjusting a transition between views of the sequence of views that are remaining.

8. A system comprising:
one or more processors;
a non-transitory computer-readable medium storing instructions that when executed by the one or more processors, cause the one or more processors to perform operations including:
receiving a frame image including one or more panels;
executing a first machine-learning model using the frame image, wherein the first machine-learning model segments the frame image into one or more image regions;
executing a second machine-learning model using the frame image, wherein the second machine-learning model identifies text and a context corresponding to the one or more panels;
generating a frame configuration using the frame image, the one or more image regions, and the context corresponding to the one or more panels, wherein the frame configuration identifies a sequence of views to present the frame image, wherein each view of the sequence of views corresponds to a panel of the one or more panels or a portion thereof; and
facilitating execution of the frame configuration causing a presentation of a first view of the sequence of views.

9. The system of claim 8, wherein the first machine-learning model performs edge detection to identify each panel of the one or more panels.

10. The system of claim 8, wherein the first machine-learning model uses the one or more image regions to determine a presentation order of the one or more panels.

11. The system of claim 8, wherein the second machine-learning model uses the context corresponding to the alphanumeric text to define a presentation order of the one or more panels.

12. The system of claim 8, wherein the operations further include:
detecting a navigation command associated with the presentation of a first view of the sequence of views; and
presenting a subsequent view of the sequence of views based on the navigation command.

13. The system of claim 12, wherein the navigation command is defined based on one of: a voice command, a gesture, device motion, eye movement, device input, or time.

14. The system of claim 12, wherein the operations further include:
modifying the frame configuration based on the navigation command, wherein modifying the frame configuration includes adjusting a transition between views of the sequence of views that are remaining.

15. A non-transitory computer-readable medium storing instructions that when executed by one or more processors, cause the one or more processors to perform operations including:
receiving a frame image including one or more panels;
executing a first machine-learning model using the frame image, wherein the first machine-learning model segments the frame image into one or more image regions;
executing a second machine-learning model using the frame image, wherein the second machine-learning model identifies a context associated with text positioned within the one or more panels;
generating a frame configuration using the frame image, the one or more image regions, and the context corresponding to the one or more panels, wherein the frame configuration identifies a sequence of views to present the frame image, wherein each view of the sequence of views corresponds to a panel of the one or more panels or a portion thereof; and
facilitating execution of the frame configuration causing a presentation of a first view of the sequence of views.

16. The non-transitory computer-readable medium of claim 15, wherein the first machine-learning model performs edge detection to identify each panel of the one or more panels.

17. The non-transitory computer-readable medium of claim 15, wherein the first machine-learning model uses the one or more image regions to determine a presentation order of the one or more panels.

18. The non-transitory computer-readable medium of claim 15, wherein the operations further include:
detecting a navigation command associated with the presentation of a first view of the sequence of views; and
presenting a subsequent view of the sequence of views based on the navigation command.

19. The non-transitory computer-readable medium of claim 18, wherein the navigation command is defined based on one of: a voice command, a gesture, device motion, eye movement, device input, or time.

20. The non-transitory computer-readable medium of claim 18, wherein the operations further include:
modifying the frame configuration based on the navigation command, wherein modifying the frame configuration includes adjusting a transition between views of the sequence of views that are remaining.
